(19) United States
(12) Patent Application Publication
(10) Pub. No.: US 2026/0088716 A1
(43) Pub. Date: Mar. 26, 2026

(54) DC-DC CONVERTER CIRCUIT

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Te BI, Tokyo (JP); Chen Kong TEH, Tokyo (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 19/034,746

(22) Filed: Jan. 23, 2025

(30) Foreign Application Priority Data
Sep. 20, 2024 (JP) 2024-163654

(51) Int. Cl. H02M 3/07; H02M 3/158

(52) U.S. Cl. CPC H02M 3/072; H02M 3/158

(57) ABSTRACT

Switches are turned on and off to establish a first state in which a first capacitor is coupled between an input node and a first node, a second capacitor and a first coil are coupled between the first node and an output node, a third capacitor and a second coil are coupled between the first node and the output node, and a second node is coupled to a first reference potential node; and a second state in which the second capacitor and the first coil are coupled between a third node and the output node, the first and third capacitors and the second coil are coupled between the third node and the output node, a fourth node is coupled to a node to which the first and third capacitors are coupled, and a fifth node is coupled to a second reference potential node.

### CROSS-REFERENCE TO RELATED APPLICATIONS

This application is based upon and claims the benefit of priority from Japanese Patent Application No. 2024-163654, filed Sep. 20, 2024, the entire contents of which are incorporated herein by reference.

### FIELD

Embodiments described herein relate generally to a DC-DC converter circuit.

### BACKGROUND

A DC-DC converter circuit is known that converts a direct current (DC) voltage into a DC voltage of a different magnitude. The DC-DC converter circuit is required to achieve high conversion efficiency, i.e., suppression of power loss.

### BRIEF DESCRIPTION OF THE DRAWINGS

FIG. 1 is a block diagram of a system including a DC-DC converter circuit of the first embodiment.

FIG. 2 is a block diagram of a voltage conversion circuit including the DC-DC converter circuit of the first embodiment.

FIG. 3 is a circuit diagram of the DC-DC converter circuit of the first embodiment.

FIG. 4 shows how the level of control signals supplied to the DC-DC converter circuit of the first embodiment change over time.

FIG. 5 shows a state during the operation of the DC-DC converter circuit of the first embodiment.

FIG. 6 shows a state during the operation of the DC-DC converter circuit of the first embodiment.

FIG. 7 shows a state during the operation of the DC-DC converter circuit of the first embodiment.

FIG. 8 shows the sequence of states during the operation of the DC-DC converter circuit of the first embodiment.

FIG. 9 is a circuit diagram of a reference DC-DC converter circuit.

FIG. 10 is a circuit diagram of a DC-DC converter circuit of the second embodiment.

FIG. 11 shows the sequence of states during the operation of the DC-DC converter circuit of the second embodiment.

FIG. 12 is a circuit diagram of the DC-DC converter circuit of the second embodiment.

FIG. 13 shows the sequence of states during the operation of the DC-DC converter circuit of the second embodiment.

### DETAILED DESCRIPTION

In general, according to one embodiment, a DC-DC converter circuit includes a first capacitor, a second capacitor, a third capacitor, a first coil, a second coil, and a plurality of switches. The plurality of switches are turned on and off to establish a first state in which the first capacitor is coupled between an input node and a first node, the second capacitor and the first coil are coupled in series between the first node and an output node, the third capacitor and the second coil are coupled in series between the first node and the output node, and a second node to which the second capacitor and the first coil are coupled is coupled to a first reference potential node; and a second state in which the second capacitor and the first coil are coupled in series between a third node and the output node, the first capacitor, the third capacitor, and the second coil are coupled in series between the third node and the output node, a fourth node to which the second capacitor and the first coil are coupled is coupled to a node to which the first capacitor and the third capacitor are coupled, and a fifth node to which the third capacitor and the second coil are coupled is coupled to a second reference potential node.

Embodiments will now be described with reference to the figures. In order to distinguish components having substantially the same function and configuration in an embodiment or over different embodiments from each other, an additional numeral or letter may be added to the end of each reference numeral or letter. For an embodiment subsequent to an embodiment that has already been described, the description will concentrate mainly on the matters that constitute a difference from the already described embodiment. The entire description of a particular embodiment applies to another embodiment unless an explicit mention is made otherwise, or an obvious elimination is involved.

The specification and the claims, when mentioning that a particular (first) component is “coupled” to another (second) component, intend to cover both the form of the first component directly coupled to the second component and the form of the first component coupled to the second component via one or more components which are always or selectively conductive.

### 1. First Embodiment

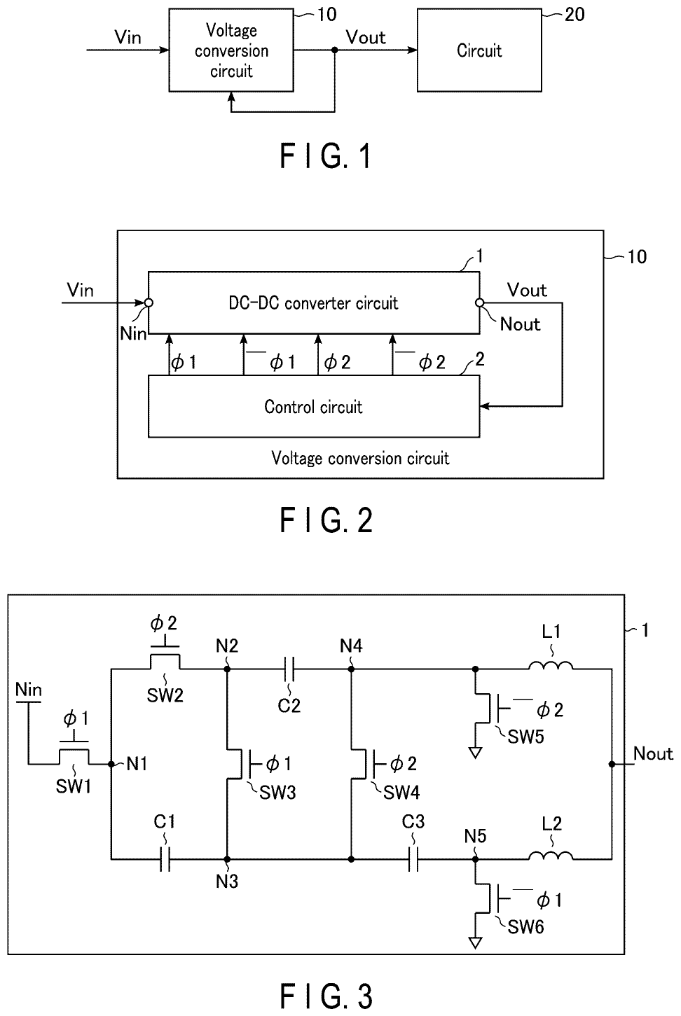

FIG. 1 is a block diagram of a system including a DC-DC converter circuit of the first embodiment. As shown in FIG. 1, a voltage conversion circuit 10 is a circuit that supplies a voltage to a circuit 20. The voltage conversion circuit 10 and the circuit 20 may be included in separate individual devices, or may be included in a single device.

The voltage conversion circuit 10 is a circuit that outputs a voltage different from a voltage the voltage conversion circuit 10 receives. The voltage conversion circuit 10 includes a DC-DC converter circuit of the first embodiment. The voltage conversion circuit 10 receives an input voltage Vin. The input voltage Vin may be supplied from a power supply device or from a commercial power source. The voltage conversion circuit 10 generates an output voltage Vout from the input voltage Vin and outputs the output voltage Vout. The output voltage Vout has a magnitude different from that of the input voltage Vin and is lower than the input voltage Vin. The voltage conversion circuit 10 receives the output voltage Vout and uses the output voltage Vout to control the magnitude of the output voltage Vout.

FIG. 2 is a block diagram of a voltage conversion circuit including the DC-DC converter circuit of the first embodiment. As shown in FIG. 2, the voltage conversion circuit 10 includes a DC-DC converter circuit 1 and a control circuit 2. The DC-DC converter circuit 1 receives an input voltage Vin, generates an output voltage Vout from the input voltage Vin, and outputs the output voltage Vout. The DC-DC converter circuit 1 receives the input voltage Vin at an input node Nin. The DC-DC converter circuit 1 outputs the output voltage Vout at an output node Nout. The DC-DC converter circuit 1 receives control signals φ1, ⁻φ1, φ2, and ⁻φ2. The DC-DC converter circuit 1 operates based on the control signals φ1, ⁻φ1, φ2, and ⁻φ2.

The control circuit 2 is a circuit that controls the DC-DC converter circuit 1, based on the voltage it receives. The control circuit 2 receives the output voltage Vout, and generates the control signals φ1, ⁺φ1, φ2, and ⁻φ2, based on the output voltage Vout. The control circuit 2 adjusts the control signals φ1, ⁻φ1, φ2, and ⁻φ2 such that the output voltage Vout has a preset magnitude. Specifically, the control signals φ1, ⁻φ1, φ2, and ⁻φ2 define the duty cycle of the DC-DC converter circuit 1. The duty cycle is the ratio of the time a transistor in the control circuit is on to the total period of the cycle. The control circuit 2 adjusts the on and off periods of the control signals φ1, ⁻φ1, φ2, and ⁻φ2 such that the transistors operate to output an output voltage Vout of a preset magnitude. The control circuit 2 lengthens the on periods of the control signals φ1, ⁻φ1, φ2, and ⁻φ2 in a case where the output voltage Vout is below the preset magnitude. The control circuit 2 shortens the on periods of the control signals φ1, ⁻φ1, φ2, and ⁻φ2 in a case where the output voltage Vout is above the preset magnitude.

FIG. 3 is a circuit diagram of the DC-DC converter circuit of the first embodiment. As shown in FIG. 3, the DC-DC converter circuit 1 includes switches SW1, SW2, SW3, SW4, SW5, and SW6, capacitors C1, C2 and C3, and coils L1 and L2. Each of the switches SW1, SW2, SW3, SW4, SW5, and SW6 remains in either the on or off state, based on the voltage of the control terminal. Each of the switches SW1, SW2, SW3, SW4, SW5, and SW6 remains in a state where both ends of the switch are electrically coupled while it is on. Each of the switches SW1, SW2, SW3, SW4, SW5, and SW6 remains in a state where both ends of the switch are electrically decoupled while it is off. Examples of the switches SW1, SW2, SW3, SW4, SW5, and SW6 include n-type or p-type metal oxide semiconductor field effect transistors (MOSFETs). In this example, the control terminals of the switches SW1, SW2, SW3, SW4, SW5, and SW6 are gate electrodes. FIG. 3 and subsequent figures are based on an example in which each of the switches SW1, SW2, SW3, SW4, SW5, and SW6 is an n-type MOSFET.

The switch SW1 is coupled between an input node Nin and a node N1. The switch SW1 receives the control signal φ1 at a control terminal thereof.

The switch SW2 is coupled between the node N1 and a node N2. The switch SW2 receives the control signal φ2 at a control terminal thereof.

The capacitor C1 is coupled between the node N1 and a node N3.

The switch SW3 is coupled between the node N2 and the node N3. The switch SW3 receives the control signal φ1 at a control terminal thereof.

The capacitor C2 is coupled between the node N2 and a node N4.

The switch SW4 is coupled between the nodes N4 and N3. The switch SW4 receives the control signal φ2 at a control terminal thereof.

The switch SW5 is coupled between the node N4 and a node that receives a ground voltage (or a reference voltage) Vss. The switch SW5 receives the control signal φ2 at a control terminal thereof. In the description below, the node that receives the reference voltage Vss may be referred to as a reference potential node Nss.

The capacitor C3 is coupled between the node N3 and a node N5.

The switch SW6 is coupled between the node N5 and the reference potential node Nss. The switch SW6 receives the control signal φ1 at a control terminal thereof.

The coil L1 is coupled between the node N4 and the output node Nout.

The coil L2 is coupled between the node N5 and the output node Nout.

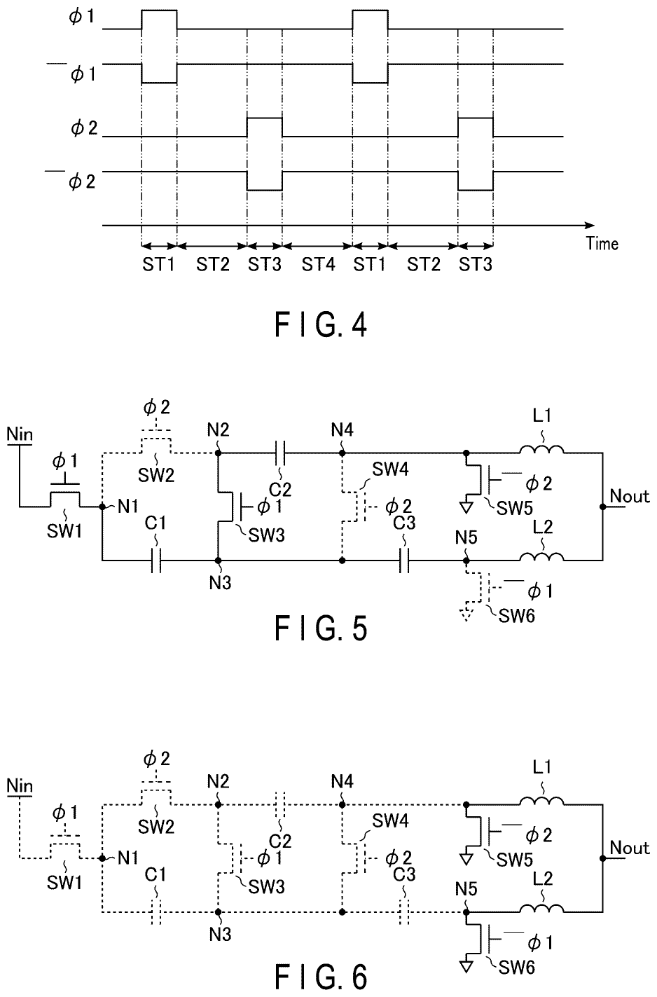

FIG. 4 shows how the level of the control signals supplied to the DC-DC converter circuit of the first embodiment change over time. The following description is based on an example in which the switches SW1, SW2, SW3, SW4, SW5, and SW6 are turned on and off by the control signals φ1, ⁻φ1, φ2, and ⁻φ2 of the levels as described below.

The switches SW1 and SW3 are on while receiving a high level or “H” level control signal φ1 and are off while receiving a low level or “L” level control signal φ1.

The switches SW2 and SW4 are on while receiving a high level or “H” level control signal φ2 and are off while receiving a low level or “L” level control signal φ2.

The switch SW5 is on while receiving a high level or “H” level control signal ⁻φ2 and is off while receiving a low level or “L” level control signal φ2.

The switch SW6 is on while receiving a high level or “H” level control signal ⁻φ1 and is off while receiving a low level or “L” level control signal ⁻φ1.

As shown in FIG. 4, the combination of the levels of the control signals φ1, ⁻φ1, φ2, and ⁻φ2 changes periodically. One period consists of the state ST1, the state ST2, the state ST3, and the state ST4. The state ST1 transitions to the state ST2. The state ST2 transitions to the state ST3. The state ST3 transitions to the state ST4. The state ST4 transitions to the state ST1.

The control signal φ1 maintains a high level during the state ST1, and maintains a low level during the states ST2, ST3, and ST4.

The control signal ⁻φ1 maintains a low level during the state ST1, and maintains a high level during the states ST2, ST3, and ST4.

The control signal φ2 maintains a high level during the state ST3, and maintains a low level during the states ST1, ST2, and ST4.

The control signal ⁻φ2 maintains a high level during the state ST3, and maintains a low level during the states ST1, ST2, and ST4.

The duty cycle D of the control signals φ1, ⁻φ1, φ2, and ⁻φ2 is defined as the ratio of the duration of the state ST1 or ST3 to the total duration of the states ST1, ST2, ST3, and ST4.

The duration of the state ST2 and the duration of the state ST4 are substantially the same. In this specification and the claims, the terms “substantially the same” and “substantially equal” are used to indicate that two elements are similar, though not exactly identical, due to limitations in manufacturing and measurement techniques.

FIG. 5 shows a state during the operation of the DC-DC converter circuit of the first embodiment. FIG. 5 shows the state ST1. As described above with reference to FIG. 4, during the state ST1, the control signals φ1 and ⁻φ2 have a high level, and the control signals ⁻φ1 and φ2 have a low level. Thus, as shown in FIG. 5, the switches SW1, SW3, and SW5 are on, and the switches SW2, SW4, and SW6 are off. The switches that are off are indicated by dashed lines. As a result, the node N1 is coupled to the input node Nin, the node N2 is decoupled from the node N1, and the node N4 is decoupled from the node N3 and coupled to a common potential node. The node N5 is not coupled to the common potential node.

FIG. 6 shows a state during the operation of the DC-DC converter circuit of the first embodiment. FIG. 6 shows the states ST2 and ST4. As described above with reference to FIG. 4, during the states ST2 and ST4, the control signals φ1 and φ2 have a low level, and the control signals ⁻φ1 and ⁻φ2 have a high level. Thus, as shown in FIG. 6, the switches SW1, SW2, SW3, and SW4 are off, and the switches SW5 and SW6 are on. As a result, the nodes N4 and N5 are each coupled to the common potential node and decoupled from the other nodes.

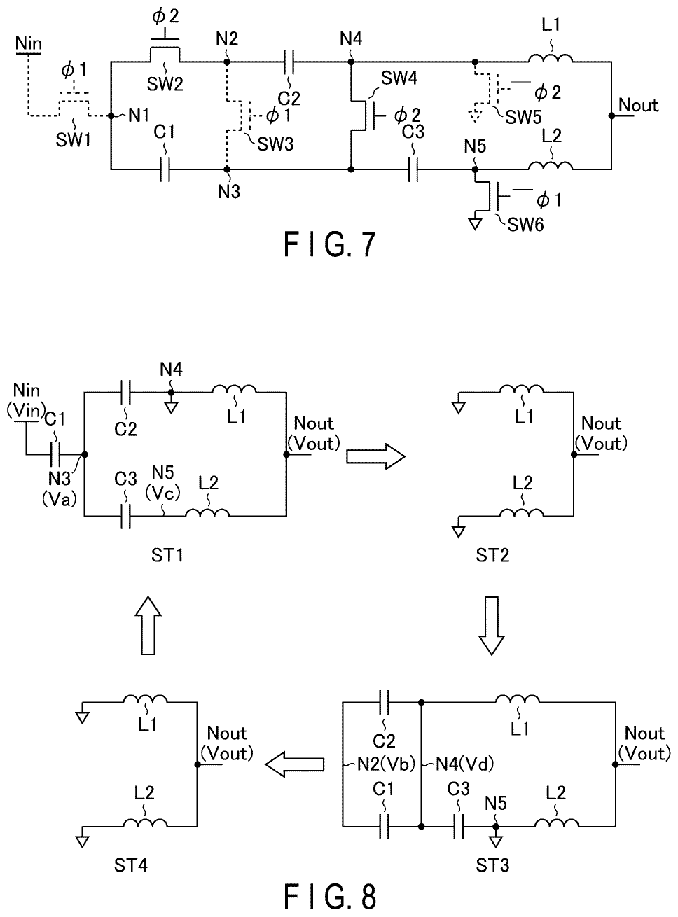

FIG. 7 shows a state during the operation of the DC-DC converter circuit of the first embodiment. FIG. 7 shows the state ST3. As described above with reference to FIG. 4, during the state ST3, the control signals φ1 and ⁻φ2 have a low level, and the control signals ⁻φ1 and φ2 have a high level. Thus, as shown in FIG. 7, the switches SW1, SW3, and SW5 are off, and the switches SW2, SW4, and SW6 are on. As a result, the node N1 is decoupled from the input node, the nodes N2 and N3 are decoupled from each other, the node N4 is coupled to the node N3 and is not coupled to the common potential node, and the node N5 is coupled to the common potential node.

FIG. 8 shows the sequence of states during the operation of the DC-DC converter circuit of the first embodiment. FIG. 8 shows equivalent circuits of FIG. 5, FIG. 6, and FIG. 7. In the upper left portion, FIG. 8 shows an equivalent circuit of the state ST1. In the upper right portion, FIG. 8 shows an equivalent circuit of the state ST2. In the lower right portion, FIG. 8 shows an equivalent circuit of the state ST3. In the lower left portion, FIG. 8 shows an equivalent circuit of the state ST4.

As shown in the upper left portion of FIG. 8, during the state ST1, the capacitors C1 and C3 are charged by the input voltage Vin. That is, each of the capacitors C1 and C3 is positively charged at the terminal closer to the input node Nin. In addition, the input voltage Vin causes a current to flow through the coil L2 via the capacitors C1 and C3. The current flowing through the coil L2 causes the coil L2 to store magnetic energy.

Since the capacitor C2 is coupled to the common potential node at the terminal opposite to the input voltage Vin, negative charge continuously flows out from the terminal opposite to the input voltage Vin, and the capacitor C2 is discharged thereby.

As described later, during the state ST3 prior to the state ST1, a current flows through the coil L1 from the input node Nin to the output node Nout, and this current causes the coil L1 to store magnetic energy. During the state ST1, the supply of current to the coil L1 stops, and the magnetic energy causes a current to flow from the coil L1 to the output node Nout.

As shown in the upper right portion of FIG. 8, during the state ST2, the current supply caused by the magnetic energy stored in the coil L1 continues. In addition, since the supply of current to the coil L2 stops, the magnetic energy stored in the coil L2 causes a current to flow from the coil L2 to the output node Nout.

As shown in the lower right portion of FIG. 8, during the state ST3, the current supply caused by the magnetic energy stored in the coil L2 continues. Furthermore, since the capacitor C1 is discharged, that is, the charge stored in the capacitor C1 flows out from the capacitor C1, a current flows through the coil L1 via the capacitor C2. Since the capacitor C3 is discharged, that is, the charge stored in the capacitor C3 flows out from the capacitor C3, a current flows through the coil L1. The current flowing through the coil L1 causes the coil L1 to store magnetic energy.

As shown in the lower left portion of FIG. 8, during the state ST4, the current supply caused by the magnetic energy stored in the coil L2 continues. In addition, since the supply of current to the coil L1 stops, the magnetic energy stored in the coil L1 causes a current to flow from the coil L1 to the output node Nout. The state ST4 transitions to the state ST1.

According to the first embodiment, a DC-DC converter circuit 1 having a high conversion efficiency is provided, as described below.

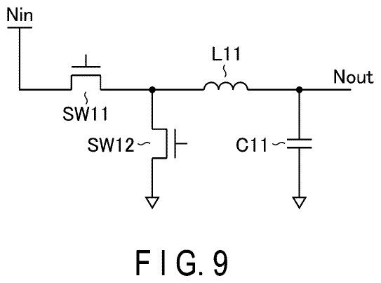

For comparison, a basic DC-DC converter circuit will be briefly described as a reference example. FIG. 9 is a circuit diagram of the reference DC-DC converter circuit. A switch SW11 and a coil L11 are coupled in series between an input node Nin and an output node Nout. A switch SW12 is coupled between a node to which the switch SW11 and the coil L11 are coupled and a common potential node. A capacitor C11 is coupled between the output node Nout and the common potential node.

The switches SW11 and SW12 are turned on alternately. While the switch SW11 is on and the switch SW12 is off, the input voltage Vin induces a voltage at the output node Nout via the coil L11 and stores magnetic energy in the coil L11. While the switch SW11 is off and the switch SW12 is on, the magnetic energy stored in the coil L11 causes a current to flow from the coil L11 to the output node Nout, which in turn generates an output voltage Vout at the output node Nout.

The equation Vout=Vin×Da holds true, where Da is the duty cycle of the switch SW1. That is, the equation Da=Vout/Vin holds true. This equation means that a small duty cycle is required to obtain a small output voltage Vout. If the duty cycle is small, the time during which the switch SW1 is on is short, so that the power loss attributable to the switch SW1 is large. In other words, the power loss is large if the voltage is lowered to a greater extent.

In the DC-DC converter circuit 1 of the first embodiment, the relationships set forth below hold true. As shown in FIG. 8, let it be assumed that the potential of the node N3 is Va, the potential of the node N5 is Vc, the potential of the node N2 is Vb, and the potential of the node N4 is Vd. In this case, in the steady state, the equations (1), (2), and (3) set forth below hold true for the terminal voltages of the capacitors C1, C2, and C3 between the state ST1 and the state ST3, according to the law of conservation of charge. In other words, the equation (1) holds true for the terminal voltage of the capacitor C1. The equation (2) holds true for the terminal voltage of the capacitor C2. The equation (3) holds true for the terminal voltage of the capacitor C3. The left side of each equation represents the terminal voltage of the capacitor C1, C2, or C3 during the state ST1. The right side of each equation represents the terminal voltage of the capacitor C1, C2, or C3 during the state ST3.

$$Vin - Va = Vb - Vd \qquad ( 1 )$$

$$Va = Vb - Vd \qquad ( 2 )$$

$$Va - Vc = Vd \qquad ( 3 )$$

Between the state ST3 and the other states, the equation (4) set forth below holds true for the coil L1 according to the principle of volt-second balance. The left side represents the state ST3, and the right side represents the states other than the state ST3.

$$D ( V d - V out ) = ( 1 - D ) V out \qquad ( 4 )$$

The Equation (4) can be transformed into the following equation (5):

$$D V d = V out \qquad ( 5 )$$

Between the state ST1 and other states, the equation (6) set forth below holds true for the coil L2 according to the principle of volt-second balance. The left side represents the state ST1, and the right side represents the states other than the state ST1.

$$D ( V c - V out ) = ( 1 - D ) V out \qquad ( 6 )$$

The equation (6) can be transformed into the following equation (7):

$$D V c = V out \qquad ( 7 )$$

From the equations (5) and (7), the following equation (8) can be obtained:

$$V d = V c \qquad ( 8 )$$

From the equations (1), (2), (3), and (8), the following equation (9) can be obtained:

$$V in = 4 V d \qquad ( 9 )$$

From the equations (5) and (9), the following equation (10) can be obtained:

$$D = 4 \times ( V out / V in ) \qquad ( 10 )$$

The equation (10) shows that in the case where the same conversion ratio (i.e., Vout/Vin) as that in the reference DC-DC converter circuit is achieved in the DC-DC converter circuit 1, the duty cycle D can be four times the duty cycle Da in the DC-DC converter circuit 1. This means that by shortening the time while the switches SW1, SW2, SW3, SW4, SW5, and SW6 are off, switching losses can be suppressed more than those of the reference DC-DC converter circuit, despite achieving the same conversion rate as the reference DC-DC converter circuit, and a highly efficient DC-DC converter circuit can be realized.

### 2. Second Embodiment

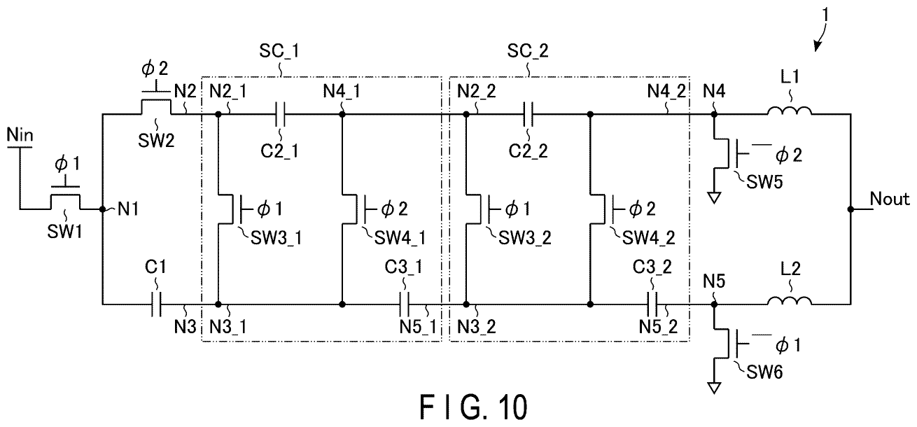

FIG. 10 is a circuit diagram of a DC-DC converter circuit of the second embodiment. As shown in FIG. 10, the DC-DC converter circuit 1 of the second embodiment includes a further set of switches SW3 and SW4 and capacitors C2 and C3, in addition to the set of switches SW3 and SW4 and capacitors C2 and C3 of the first embodiment. The set of switches SW3 and SW4 and capacitors C2 and C3 of the first embodiment may be referred to as a switch-capacitor set SC_1. The switches SW3 and SW4 and capacitors C2 and C3 of the switch-capacitor set SC_1 may be referred to as switches SW3_1 and SW4_1 and capacitors C2_1 and C3_1, respectively. The second set of switches SW3 and SW4 and capacitors C2 and C3 may be referred to as a switch-capacitor set SC_2. The switches SW3 and SW4 and capacitors C2 and C3 of the switch-capacitor set SC_2 may be referred to as switches SW3_2 and SW4_2 and capacitors C2_2 and C3_2, respectively.

The switch-capacitor sets SC_1 and SC_2 are coupled in series between the node N2 and the node N4 and between the node 3 and the node N5. The components are coupled in the same manner in the two switch-capacitor sets SC. The corresponding switches of the two switch-capacitor sets SC receive the same signal at their respective control terminals. Specifics of this will be described.

The node to which the capacitor C2_1 and the switch SW3_1 are coupled may be referred to as a node N2_1. The node N2_1 is coupled to the node N2 and corresponds to the node N2.

The node to which the capacitor C1 and the switch SW3_1 are coupled may be referred to as a node N3_1. The node N3_1 is coupled to the node N3 and corresponds to the node N3.

The node to which the capacitor C2_1 and the switch SW4_1 are coupled may be referred to as a node N4_1. The node on the opposite side of the node N3_1 of the capacitor C3_1 may be referred to as a node N5_1.

The switch SW3_2 is coupled between the nodes N2_2 and N3_2. The switch SW3_2 receives the control signal φ1 at a control terminal thereof. The node N2_2 is coupled to the node N4_1 and corresponds to the node N4_1. The node N3_2 is coupled to the node N5_1 and corresponds to the node N5_1.

The capacitor C2_2 is coupled between the nodes N2_2 and N4_2. The node 4_2 is coupled to the node N4 and corresponds to the node N4.

The switch SW4_2 is coupled between the nodes N2_2 and N3_2. The switch SW4_2 receives a control signal φ2 at a control terminal thereof.

The capacitor C3_2 is coupled between the nodes N3_2 and N5_2. The node 5_2 is coupled to the node N5 and corresponds to the node N5.

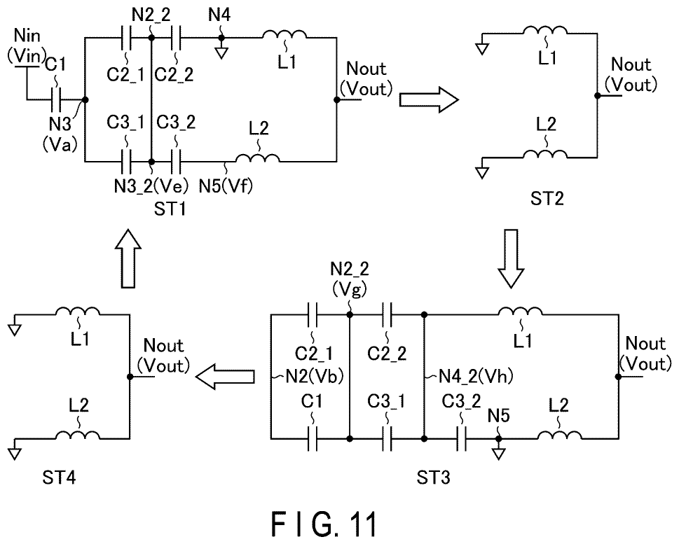

FIG. 11 shows the sequence of states during the operation of the DC-DC converter circuit of the second embodiment. FIG. 11 shows equivalent circuits of the states ST1, ST2, ST3, and ST4. In the upper left portion, FIG. 11 shows an equivalent circuit of the state ST1. In the lower right portion, FIG. 11 shows an equivalent circuit of the state ST3. The equivalent circuits of the states ST2 and ST4 are the same as those of the first embodiment (FIG. 8).

As shown in FIG. 11, during the state ST1, the capacitors C2_1, C2_2 and the coil L1 are coupled in series in this order between the input node Nin and the output node Nout. During the state ST1, the capacitors C3_1, C3_2 and the coil L2 are coupled in series in this order between the node to which the capacitors C1 and C2_2 are coupled (i.e., the node N3) and the output node Nout. During the state ST1, the node to which the capacitors C2_1 and C2_2 are coupled (i.e., the node N2_2) is coupled to the node to which the capacitors C3_1 and C3_2 are coupled (i.e., the node N3_2). During the state ST1, the node to which the capacitor C2_2 and the coil L1 are coupled (i.e., the node N4) is coupled to the reference potential node Nss.

During the state ST3, the capacitors C2_1, C2_2 and the coil L1 are coupled in series in this order between the node to which the capacitors C2_1 and C1 are coupled (i.e., the node N2) and the output node Nout. During the state ST3, the capacitors C1, C3_1, C3_2, and the coil L2 are coupled in series in this order between the node to which the capacitors C2_1 and C1 are coupled (i.e., the node N2_2) and the output node Nout. During the state ST3, the node to which the capacitors C2_2 and the coil L1 are coupled (i.e., the node N4_2) is coupled to the node to which the capacitors C3_1 and C3_2 are coupled (i.e., the node N3_2). During the state ST3, the node to which the capacitor C3_2 and the coil L2 are coupled (i.e., the node N5) is coupled to the reference potential node Nss.

In the DC-DC converter circuit 1b of the second embodiment, the relationships mentioned below hold true. Let it be assumed that the potential of the node N3_2 is Ve, the potential of the node N5 is Vf, the potential of the node N2_2 is Vg, and the potential of the node N4_2 is Vh. In the steady state, the equations (11), (12), (13), (14), and (15) hold true for the terminal voltages of the capacitors C1, C2_1, C3_1, C2_2, and C3_2 between the state ST1 and the state ST3, according to the law of conservation of charge. In other words, the equation (11) set forth below holds true for the terminal voltage of the capacitor C1. The equation (12) holds true for the terminal voltage of the capacitor C2_1. The equation (13) holds true for the terminal voltage of the capacitor C3_1. The equation (14) holds true for the terminal voltage of the capacitor C2_2. The equation (15) holds true for the terminal voltage of the capacitor C3_2. The left side of each equation represents the terminal voltage of the capacitor C1, C2_1, C3_1, or C3_2 during the state ST1. The right side of each equation represents the terminal voltage of the capacitor C1, C2_1, C3_1, C2_2 or C3_2 during the state ST3.

$$V in - V a = V b - V g \qquad ( 11 )$$

$$V a - V e = V b - V g \qquad ( 12 )$$

$$V a - V e = V g - V h \qquad ( 13 )$$

$$V e = V g - V h \qquad ( 14 )$$

$$V e - V f = V h \qquad ( 15 )$$

Between the state ST3 and other states, the equation (16) set forth below holds true for the coil L1 according to the law of volt-second balance. The left side represents the state ST3, and the right side represents the states other than the state ST3.

D(Vh−Vout)=(1−D)Vout (16)
The equation (16) can be transformed into the following equation (17):

$$D V h = V out \qquad ( 17 )$$

Between the state ST1 and other states, the equation (18) set forth below holds true for the coil L2 according to the law of volt-second balance. The left side represents the state ST1, and the right side represents the states other than the state ST3.

$$D ( V f - V out ) = ( 1 - D ) V out \qquad ( 18 )$$

The equation (18) can be transformed into the following equation (19):

$$D V f = V out \qquad ( 19 )$$

From the equations (17) and (19), the following equation (20) can be obtained:

$$V f = V h \qquad ( 20 )$$

From the equations (11), (12), (13), (14), (15), (16) and (20), the following equation (21) can be obtained:

$$V in = 6 V h \qquad ( 21 )$$

From the equations (17) and (21), the following equation (22) can be obtained:

$$D = 6 \times ( V out / V in ) \qquad ( 22 )$$

The equation (22) shows that in the case where the same conversion ratio (i.e., Vout/Vin) as in the reference DC-DC converter circuit is achieved in the DC-DC converter circuit 1, the duty cycle D can be six times the duty cycle Da achieved in the reference DC-DC converter circuit. That is, the duty cycle D can be made even larger than that in the first embodiment.

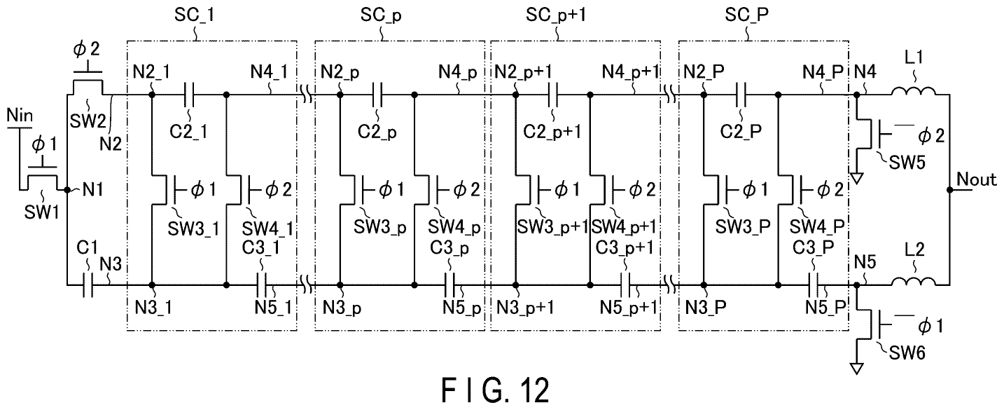

As shown in FIG. 12, three or more switch-capacitor sets SC may be provided. In this case, the plurality of switch-capacitor sets SC are coupled in series between the node N2 and the node N4 and between the node N3 and the node N5, as in the case described above with reference to FIG. 10. A generalized description, including the case where two switch-capacitor sets SC are provided, is as follows.

For each case where p is an integer of 1 to P, the switch-capacitor set SC_p includes switches SW3_p and SW4_p and capacitors C2_p and C3_p. For each case where p is 1 to P, the switch SW3_p is coupled between the node N2_p and the node N3_p. For each case where p is 1 to P, the switch SW3_p receives the control signal φ1 at a control terminal thereof. For each case where p is 1 to P, the switch SW4_p is coupled between the node N4_p and the node N3_p. For each case where p is 1 to P, the switch SW4_p receives the control signal φ2 at a control terminal thereof.

The node N2_1 of the switch-capacitor set SC_1 is coupled to the node N2. The node N3_1 of the switch-capacitor set SC_1 is coupled to the node N3.

For each case where p is 1 to P, the node N4_p of the switch-capacitor set SC_p is coupled to the node N2_p+1 of the switch-capacitor set SC_p+1. For each case where p is 1 to P, the node N5_p of the switch-capacitor set SC_p is coupled to the node N3_p+1 of the switch-capacitor set SC_p+1.

The node N4_P of the switch-capacitor set SC_P is coupled to the node N4. The node N5_P of the switch-capacitor set SC_P is coupled to the node N5.

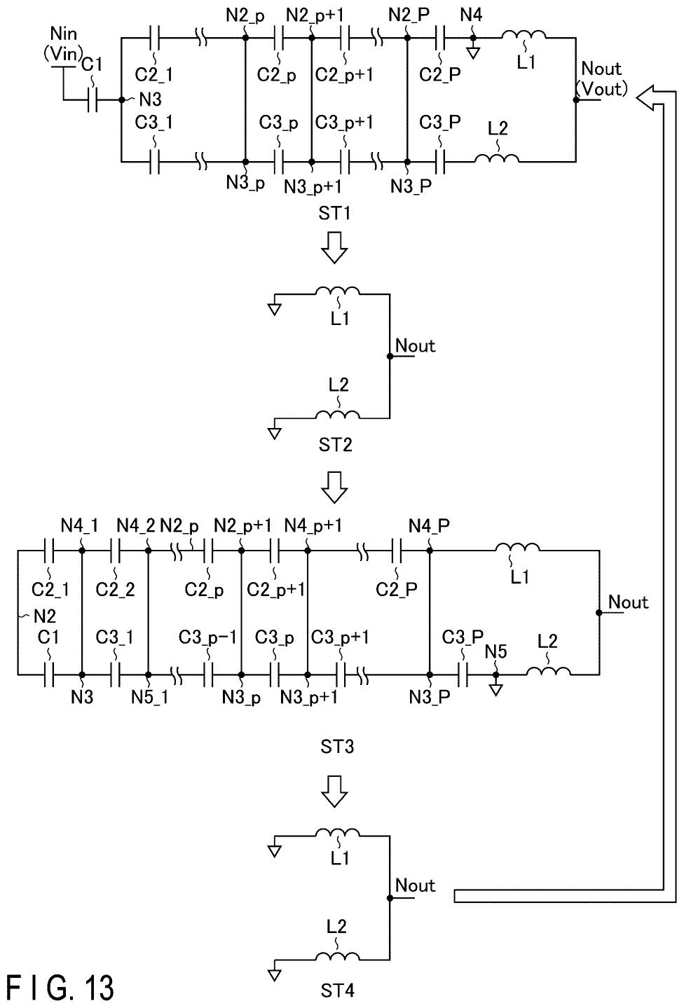

FIG. 13 shows the sequence of states during the operation of the DC-DC converter circuit of the second embodiment. FIG. 13 shows equivalent circuits of the states ST1, ST2, ST3, and ST4 from top to bottom. The equivalent circuits of the states ST2 and ST4 are the same as those of the first embodiment (FIG. 8).

As shown in FIG. 13, during the state ST1, the capacitors C2 (C2_1, C2_2, . . . , C2_p, C2_p+1, . . . , C2_P) of the P switch-capacitor sets SC and the coil L1 are coupled in series in this order between the input node Nin and the output node Nout. During the state ST1, the capacitors C3 (C3_1, C3_2, . . . , C3_p, C3_p+1, . . . , C3_P) of the P switch-capacitor sets SC and the coil L2 are coupled in series in this order between the node to which the capacitors C1 and C2_2 are coupled (i.e., the node N3) and the output node Nout. During the state ST1, for each case where p is 1 to P-1, the node to which the capacitors C2_p and C2_p+1 are coupled (i.e., the node N2_p+1) is coupled to the node to which the capacitors C3_p and C3_p+1 are coupled (i.e., the node N3_p+1). During the state ST1, the node to which the capacitor C2_P and the coil L1 are coupled (i.e., the node N4) is coupled to the reference potential node Nss.

During the state ST3, the capacitors C2 (C2_1, C2_2, . . . , C2_p, C2_p+1, . . . , C2_P) of the P switch-capacitor sets SC and the coil L1 are coupled in series in this order between the node to which the capacitor C2_1 and the capacitor C1 are coupled (i.e., the node N2) and the output node Nout. During the state ST3, the capacitors C3 (C3_1, C3_2, . . . , C3_p, C3_p+1, . . . , C3_P) of the P switch-capacitor sets SC and the coil L2 are coupled in series in this order between the node to which the capacitor C2_1 and the capacitor C1 are coupled (i.e., the node N2) and the output node Nout, the capacitor C1. During the state ST3, the node to which the capacitors C2_1 and C2_2 are coupled (i.e., the node N4_1) is coupled to the node to which the capacitors C1 and C3_1 are coupled (i.e., the node N3). During the state ST3, for each case where p is 2 to P−1, the node to which the capacitors C2_p and C2_p+1 are coupled (i.e., the node N2_p+1) is coupled to the node to which the capacitors C3_p−1 and C3_p are coupled (i.e., the node N3_p). During the state ST3, the node to which the capacitor C2_P and the coil L1 are coupled (i.e., the node N4_P) is coupled to the node to which the capacitors C3_P−1 and C3_P are coupled (i.e., the node N3_P). During the state ST3, the node to which the capacitor C3_P and the coil L2 are coupled (i.e., the node N5) is coupled to the reference potential node Nss.

The formula (23) set forth below holds true for the duty cycle D in the DC-DC converter circuit 1b including P switch-capacitor sets SC. In the formula (23), x is the total number of capacitors C1, C2, and C3 included in the DC-DC converter circuit 1. That is, in the case where P switch-capacitor sets SC are included, x=1+2×P.

$$D = ( x + 1 ) \times ( V out / V in ) \qquad ( 23 )$$

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A DC-DC converter circuit comprising:
a first capacitor, a second capacitor, a third capacitor, a first coil, a second coil, and a plurality of switches,
wherein the plurality of switches are turned on and off to establish:
a first state in which the first capacitor is coupled between an input node and a first node, the second capacitor and the first coil are coupled in series between the first node and an output node, the third capacitor and the second coil are coupled in series between the first node and the output node, and a second node to which the second capacitor and the first coil are coupled is coupled to a first reference potential node; and
a second state in which the second capacitor and the first coil are coupled in series between a third node and the output node, the first capacitor, the third capacitor, and the second coil are coupled in series between the third node and the output node, a fourth node to which the second capacitor and the first coil are coupled is coupled to a node to which the first capacitor and the third capacitor are coupled, and a fifth node to which the third capacitor and the second coil are coupled is coupled to a second reference potential node.

2. The DC-DC converter circuit according to claim 1, wherein the plurality of switches are turned on and off to establish a third state in which the first coil is coupled between the first reference potential node and the output node, and the second coil is coupled between the second reference potential node and the output node.

3. The DC-DC converter circuit according to claim 2, wherein the plurality of switches are turned on and off such that the first state transitions to the third state, the third state transitions to the second state, the second state transitions to the third state, and the third state transitions to the first state.

4. The DC-DC converter circuit according to claim 1, wherein the plurality of switches include:
a first switch between the input node and the first capacitor;
a second switch between the first switch and the third node;
a third switch between the third node and the first node;
a fourth switch between the second node and the first node;
a fifth switch between the second node and the first reference potential node; and
a sixth switch between the fifth node and the second reference potential node.

5. The DC-DC converter circuit according to claim 2, wherein the plurality of switches include:
a first switch between the input node and the first capacitor;
a second switch between the first switch and the third node;
a third switch between the third node and the first node;
a fourth switch between the second node and the first node;
a fifth switch between the second node and the first reference potential node; and
a sixth switch between the fifth node and the second reference potential node.

6. The DC-DC converter circuit according to claim 3, wherein the plurality of switches include:
a first switch between the input node and the first capacitor;
a second switch between the first switch and the third node;
a third switch between the third node and the first node;
a fourth switch between the second node and the first node;
a fifth switch between the second node and the first reference potential node; and
a sixth switch between the fifth node and the second reference potential node.

7. A DC-DC converter circuit comprising:
a first capacitor;
first to P-th capacitor sets (P is an integer of 2 or more) each including a second capacitor and a third capacitor;
a first coil;
a second coil; and
a plurality of switches,
wherein the plurality of switches are turned on and off to establish:
a first state in which the first capacitor is coupled between an input node and a first node, the second capacitors of the first to P-th capacitor sets and the first coil are coupled in series between the first node and an output node, the third capacitors of the first to P-th capacitor sets and the second coil are coupled in series between the first node and the output node, and in each case where p is 1 to P−1, a second node to which the second capacitor of the p-th capacitor set and the second capacitor of the (p+1)th capacitor set are coupled is coupled to a node to which the third capacitor of the p-th capacitor set and the third capacitor of the (p+1)th capacitor set are coupled, and a third node to which the second capacitor of the P-th capacitor set and the first coil are coupled is coupled to a first reference potential node; and
a second state in which the second capacitors of the first to P-th capacitor sets and the first coil are coupled in series between a fourth node and the output node, the first capacitor, the third capacitors of the first to P-th capacitor sets, and the second coil are coupled in series between the fourth node and the output node, a node to which the second capacitor of the first capacitor set and the second capacitor of the second capacitor set are coupled is coupled to the first node, and in each case where p is 2 to P−1, a node to which the second capacitor of the p-th capacitor set and the second capacitor of the (p+1)th capacitor set are coupled is coupled to a fifth node to which the third capacitor of the (p−1)th capacitor set and the third capacitor of the p-th capacitor set are coupled, a node to which the second capacitor of the P-th capacitor set and the first coil are coupled is coupled to a node to which the third capacitor of the (P−1)th capacitor set and the third capacitor of the P-th capacitor set are coupled, and a sixth node to which the third capacitor of the P-th capacitor set and the second coil are coupled is coupled to a second reference potential node.

8. The DC-DC converter circuit according to claim 7, wherein the plurality of switches are turned on and off to establish a third state in which the first coil is coupled between the first reference potential node and the output node, and the second coil is coupled between the second reference potential node and the output node.

9. The DC-DC converter circuit according to claim 8, wherein the plurality of switches are turned on and off such that the first state transitions to the third state, the third state transitions to the second state, the second state transitions to the third state, and the third state transitions to the first state.

10. The DC-DC converter circuit according to claim 7, wherein the plurality of switches include:
a first switch between the input node and the first capacitor;
a second switch between the first switch and the fourth node;
in each case where q is 1 to P, a third switch between the second capacitor of a q-th capacitor set and the fifth node of the q-th capacitor set;
in each case where q is 1 to P, a fourth switch between the second node of the q-th capacitor set and the fifth node of the q-th capacitor set;
a fifth switch between the third node and the first reference potential node; and
a sixth switch between the sixth node and the second reference potential node.

11. The DC-DC converter circuit according to claim 8, wherein the plurality of switches include:
a first switch between the input node and the first capacitor;
a second switch between the first switch and the fourth node;
in each case where q is 1 to P, a third switch between the second capacitor of a q-th capacitor set and the fifth node of the q-th capacitor set;
in each case where q is 1 to P, a fourth switch between the second node of the q-th capacitor set and the fifth node of the q-th capacitor set;
a fifth switch between the third node and the first reference potential node; and
a sixth switch between the sixth node and the second reference potential node.

12. The DC-DC converter circuit according to claim 9, wherein the plurality of switches include:
a first switch between the input node and the first capacitor;
a second switch between the first switch and the fourth node;
in each case where q is 1 to P, a third switch between the second capacitor of a q-th capacitor set and the fifth node of the q-th capacitor set;
in each case where q is 1 to P, a fourth switch between the second node of the q-th capacitor set and the fifth node of the q-th capacitor set;
a fifth switch between the third node and the first reference potential node; and
a sixth switch between the sixth node and the second reference potential node.
